(19) United States
(12) Patent Application Publication
(10) Pub. No.: US 2008/0088715 A1
(43) Pub. Date: Apr. 17, 2008

(54) Image capture apparatus, signal processing apparatus, signal processing method and computer program product

(76) Inventor: Shigeru Hagiwara, Kanagawa (JP)

Correspondence Address: FROMMER LAWRENCE & HAUG LLP, 745 FIFTH AVENUE, NEW YORK, NY, 10151, US

(21) Appl. No.: 11/974,937

(22) Filed: Oct. 15, 2007

(30) Foreign Application Priority Data
Oct. 17, 2006 (JP) P2006-282234

(51) Int. Cl. H04N 5/228; H04N 5/335

(52) U.S. Cl. 348/222.1; 348/296; 348/311; 348/E05.091; 348/E05.031

(57) ABSTRACT

An image capture apparatus includes a charge coupled device (CCD), an analog front end circuit, and a control unit. The CCD individually output an image capture signal corresponding to each of divided areas of an image capture area through a horizontal CCD. The analog front end circuit includes an amplifier and a digital converting unit for converting into digital data. The control unit controls a drive level of a reset gate signal for resetting process of the horizontal CCD, and controls the drive level of the reset gate signal according to a gain setting value of the amplifier to lower the drive level of the reset gate signal when the gain setting value of the amplifier is relatively low, and to raise the drive level of the reset gate signal when the gain setting value of the amplifier is relatively high.

### BACKGROUND OF THE INVENTION

1. Field of the Invention

The present invention relates to an image capture apparatus, a signal processing apparatus, a signal processing method and a computer program product.

2. Description of Related Art

Charge Coupled Devices (CCDs) are widely used as image capture devices to cameras such as video cameras and still cameras, for example. In general types of existing CCDs, after imaging information for one frame is detected with a large number of photo detectors (PDs), charge signals resulting from photoelectric conversion are read out through a vertical CCD and a horizontal CCD to convert into data stream, and then the data stream are outputted from one output channel. A CCD of this one-channel output type and the signal processing configuration are described with reference to FIG. 1.

A CCD 10 shown in FIG. 1 has a vertical CCD 11 for transferring, in a vertical direction, accumulated charges in photo detectors (PDs) configured as image capture devices constituting the CCD, and a horizontal CCD 12 for transferring, in a horizontal direction one line at a time, the charges transferred from the vertical CCD 11. The horizontal CCD 12 has a horizontal register 13 for accumulating charges corresponding to each line, and an output amplifier 14 for converting the charges in the horizontal register 13 into voltage, whereby output of the output amplifier 14 is inputted into an analog front end (AFE) 21.

The analog front end (AFE) 21 is composed of circuits such as a CDS circuit for canceling noise in input signals, an amplifier (AMP) circuit for controlling a gain of the input signal and a digital converting unit (ADC) for performing AD conversion. A digital signal processed in the analog front end (AFE) 21 is further processed to the processed digital signal in a digital signal processor (DSP) 22, and is outputted to provide an output image 30 as shown in FIG. 1, for example.

In recent years, with a demand for increasing signal processing speed and/or in number of pixels in the CCD, there has been proposed one configuration, or a two-channel output CCD, which performs, by dividing output from the CCD into more than one area, parallel processing with respect to the divided output areas to provide synthesized output. The two-channel output CCD of the configuration enables faster signal processing to be realized. Specifically, if two-channel output is given from the single CCD, it is possible to perform signal processing with respect to output data at an operating frequency as much as a half of an operating frequency for one-channel output.

A signal processing configuration of the two-channel output CCD is described with reference to FIG. 2. A CCD 50 shown in FIG. 2 has a vertical CCD (or a vertical register) 51 for transferring, in a vertical direction, accumulated charges in photo detectors (PDs) configured as image capture devices constituting the CCD, and first and second horizontal CCDs 52 and 53 for transferring, in a horizontal direction one line at a time, the charges received through the vertical CCD 51. The first horizontal CCD 52 receives output corresponding to the left half of the photo detectors constituting the CCD 50, while the second horizontal CCD 53 receives output corresponding to the right half thereof.

Stored data in the first horizontal register 54 of the first horizontal CCD 52 are inputted into an analog front end (AFE) 62 after the charges are converted into the voltage by an output amplifier 56. Stored data in the second horizontal register 55 of the second horizontal CCD 53 are inputted into an analog front end (AFE) 61 after the charges are converted into the voltage by an output amplifier 57.

The analog front ends (AFEs) 61 and 62 are each composed of circuits such as a CDS circuit for canceling noise in input signals, an amplifier (AMP) circuit for performing a gain control and a digital converting (ADC) unit for performing AD conversion. The two analog front ends (AFES) 61 and 62 each perform, in parallel, the processing with respect to output data corresponding to a half of the pixels in the CCD, thereby realizing a high-speed processing.

The data processed by the signal processing is further processed to the digital signals and is synthesized in a digital signal processing (DSP) 63, whereby the processed signal are outputted to provide an output image 70 as shown in FIG. 2, for example.

The two-channel output CCD of the configuration shown in FIG. 2 makes it possible to increase an image output speed in such a manner as to perform, by dividing an image capture area of the CCD into left and right areas, data transfer and signal processing in parallel through the horizontal CCDs 52 and 53 in the left and the right areas. However, a need exists for use two or more output amplifiers 56 and 57 and two or more analog front ends (AFES) 61 and 62, resulting in an output level difference depending on a difference in characteristics of the output amplifiers 56 and 57 and/or of the analog front ends (AFES) 61 and 62.

The analog front ends (AFES) 61 and 62 include respectively therein the amplifier units (AMPS) for performing the gain control. The signals are amplified in the amplifying units (AMPs), and then the amplified signals are outputted as digital images through the digital converting units (ADCs). If the characteristics of the amplifier units (AMPS) and the digital converting units (ADCs) in the analog front ends (AFES) 61 and 62 are exactly the same, and there is no other factor of occurrence of a signal difference, the output image 70 appears just as a single output image without making any difference with respect to left and right areas. However, in actuality, there is a difference in outputted signals depending on the difference in characteristics between components included in the left and the right analog front ends (AFES) 61 and 62, and as a result, the output image 70 has a difference between left and right levels as shown in FIG. 2, with a border line at the center to come in sight.

The factors of occurrence of the difference between left and right characteristics with respect to the output image may be broadly grouped into the following three categories:
(1) There arises a phase difference in clocks applied to the two horizontal CCDs,
(2) There is a difference in characteristics of the output amplifiers of the CCDs, and
(3) There is a difference in characteristics of the gain amplifiers of the AFES.

It may be considered that elimination of the factors of occurrence of the characteristic difference is adaptable to remove the difference between the left and the right characteristics with respect to the output image. In the factors (1) to (3), the factor (1) is resolved by strictly managing of a substrate trace. The factors (2) and (3) are those resulting from problems involved in device manufacturing, and it is a fact that there is a certain degree of manufacturing variations. The factor (2) is supposed to be further divided into the following two categories:
(2A) There is a difference in transfer characteristics between left and right horizontal CCDs, and
(2B) There is a difference in characteristics between left and right floating diffusion amplifiers at the final stage of the horizontal CCDs.

The floating diffusion amplifiers at the final stage of the horizontal CCDs are referred to the output amplifiers 56 and 57 shown in FIG. 2, which generate input signals with respect to the corresponding analog front ends (AFEs) 61 and 62 by amplifying the charges after being converted into the voltage. The output amplifier characteristics depend on manufacturing variations, and it is thus quite difficult to completely match amplifier characteristic values.

To make an image capture area boundary inconspicuous by correcting the difference between the left and the right levels, the output levels of left and right area images are matched. For example, one technique exists, which performs a computation and compares output levels of left and right area images, to thereby correct one level so as to match the other level. For example, Japanese Patent No. 3619077 discloses a level control configuration based on the technique. However, when applying this technique to the level control configuration, it becomes necessary to make a level comparison after selecting highly correlated pixel areas, or areas having an image of the same subject such as blank areas in the left and the right area images, for example, from pixels of each divided area. Accordingly, the processing such as determining of correlativity and selecting of the highly correlated pixel areas is required for level control. Further, a problem exists that a failure to find any highly correlated pixel area in each divided area results in infeasibility of the processing.

In Japanese Unexamined Patent Application Publication No. 2002-252808, there is disclosed a configuration of correcting a difference between left and right levels by determining a gain correction value in such a manner as to make leveling of pixel data with respect to left and right channels over two or more lines, to calculate a difference between the leveled pixel data. However, the configuration of this type also requires the processing with the considerations of correlativity between the divided areas, resulting in the same problem as described above.

In Japanese Unexamined Patent Application Publication No. 2003-143491, there is disclosed a configuration of adjusting a control system to reduce a level difference by installing the control system for independently controlling output from each of left and right channels. However, such a configuration needs to install the control system newly, resulting in a problem of an increase in circuit scale and/or in cost.

In Japanese Unexamined Patent Application Publication No. 2004-64404, there is disclosed a configuration of providing level-controlling data by detecting a level difference between divided areas based on imaging data resulting from imaging in a light shielded state with an image capture apparatus, thereby performing level controlling to the imaging data. However, such a configuration involves a need for control-parameter acquiring processing before the image capture.

As described above, use of the two-channel output CCD may bring about some differences between left and right output image luminance levels depending on the variations in transfer characteristics of the left and the right horizontal CCDs and/or characteristics of the left and the right output amplifier units, often resulting in an appearance of a more conspicuous boundary in a center image portion of the image capture area. While there have been proposed some techniques as to those for eliminating these differences, any of these techniques require additional configurations for the processing such as control-data acquiring and analyzing, and also involve the problem that the failure to find any highly correlated pixel area in each divided area results in infeasibility of the processing.

Adjustment of the gain control amplifier units (AMPs) in the analog front ends (AFEs) 61 and 62 may be suggested as one simple technique to eliminate the difference between the left and the right area images. Specifically, this technique is to minimize the boundary between the images by performing adjustments of gain setting with respect to the left and the right areas respectively to give different values. However, the gain characteristics of the gain control amplifier units (AMPs) are not always equal between two LSIs constituting the analog front ends (AFEs) 61 and 62, so that it has been supposed that the boundary is difficult to reduce when a subject having uniform brightness and darkness (or of a type covering a wide dynamic range) is imaged. Further, it is difficult to specify the difference in characteristics between the two gain control amplifiers in advance, thereby creating difficulty in determining individual gain setting values.

### SUMMARY OF THE INVENTION

The present invention addresses the identified problems and is to provide an image capture apparatus, a signal processing apparatus, a signal processing method and a computer program product, which are configured to correct output signals from a CCD having two or more divided outputs, with a simple configuration, thereby eliminating a discontinuity at a boundary between divided image areas. Namely, a signal processing on a divided-area basis with eliminating the noncontiguous boundary is provided.

In accordance with a first aspect of the present invention, there is provided an image capture apparatus which includes a CCD for individually outputting an image capture signal corresponding to each of divided areas (split areas) of an image capture area through horizontal CCDs; an analog front end circuit, configured as a signal processing circuit with respect to output from each horizontal CCD, including an amplifier and a digital converting unit for converting into digital data; and a control unit for controlling a drive level of a reset gate signal for resetting process of the horizontal CCD. The control unit controls the reset gate signal drive level according to a gain setting value of the amplifier in the analog front end circuit, specifically, to lower the reset gate signal drive level when the amplifier gain setting value is relatively low, and to raise the reset gate signal drive level when the amplifier gain setting value is relatively high.

In one embodiment of the image capture apparatus according to the present invention, the control unit controls so as to lower the reset gate signal drive level when the amplifier gain setting value is lower than a predetermined lower threshold value, and raise the reset gate signal drive level when the amplifier gain setting value is higher than a predetermined upper threshold value.

Further, in one embodiment of the image capture apparatus according to the present invention, the control unit determines the reset gate signal drive level according to the amplifier gain setting value by referring to a table listing a correspondence between the amplifier gain setting value and a setting of the reset gate signal drive level.

Furthermore, in one embodiment of the image capture apparatus according to the present invention, the analog front end circuit has a horizontal CCD drive signal generating unit configured as a reset gate signal output unit, the control unit outputs setting information on the reset gate signal drive level to the horizontal CCD drive signal generating unit. The horizontal CCD drive signal generating unit controls the reset gate signal drive level based on the setting information inputted from the control unit to output the reset gate signal to the horizontal CCD.

Furthermore, in one embodiment of the image capture apparatus according to the present invention, the reset gate signal is a signal for resetting potential of the horizontal CCD to a reference potential through neutralizing of residual charges in a floating capacity of a floating diffusion amplifier unit in the horizontal CCD. The control unit determines the reset gate signal drive level according to the gain setting value of the amplifier in the analog front end circuit, and outputs the reset gate signal having an output pulse shape corresponding to the determined drive level.

In accordance with second aspect of the present invention, there is provided a signal processing apparatus for controlling a signal outputted from a CCD which individually outputs two or more image capture signal corresponding to each of divided areas of an image capture area through different horizontal CCDs, which includes: a control unit for determining a drive level of a reset gate signal for resetting of each horizontal CCD according to a gain setting value of an amplifier in an analog front end circuit configured as a signal processing circuit with respect to output from each horizontal CCD; and a drive signal generating unit for generating a reset gate signal corresponding to the drive level determined by the control unit, and outputting the generated reset signal to each horizontal CCD. The control unit controls the reset gate signal drive level so as to lower the reset gate signal drive level when the amplifier gain setting value is relatively low, and raise the reset gate signal drive level when the amplifier gain setting value is relatively high.

In one embodiment of the signal processing apparatus according to the present invention, the control unit controls so as to lower the reset gate signal drive level when the amplifier gain setting value is lower than a predetermined lower threshold value, and to raise the reset gate signal drive level when the amplifier gain setting value is higher than a predetermined upper threshold value.

Further, in one embodiment of the signal processing apparatus according to the present invention, the control unit determines the reset gate signal drive level according to the amplifier gain setting value by referring to a table listing a correspondence between the amplifier gain setting value and a setting of the reset gate signal drive level.

Furthermore, in one embodiment of the signal processing apparatus according to the present invention, the reset gate signal is a signal for performing restoration of a potential of the horizontal CCD to a reference potential through neutralizing of residual charges in a floating capacity of a floating diffusion amplifier unit in the each horizontal CCD. The control unit determines the reset gate signal drive level according to the gain setting value of the amplifier in the analog front end circuit, and causes an output a reset gate signal having an output pulse shape corresponding to the determined drive level.

In accordance with a third aspect of the present invention, there is provided a signal processing method, for controlling a signal outputted from a CCD which individually outputs image capture signals corresponding to each of divided areas of an image capture area through different horizontal CCDs (Charge Coupled Devices), which includes the steps of: determining, by a control unit, a drive level of a reset gate signal for resetting process of each of the horizontal CCD according to a gain setting value of an amplifier in an analog front end circuit configured as a signal processing circuit with respect to output from each of the horizontal CCD; and generating a reset gate signal corresponding to a drive level determined by the control unit, and outputting the generated reset gate signal to the horizontal CCDs. The level determining step includes: lowering the reset gate signal drive level when the amplifier gain setting value is relatively low, and raising the reset gate signal drive level when the amplifier gain setting value is relatively high.

In accordance with a fourth aspect of the present invention, there is provided a computer program product to perform signal processing in a signal processing apparatus for controlling a signal outputted from a CCD which individually outputs image capture signals corresponding to each of divided areas of an image capture area through different horizontal CCDs), which includes the steps of: determining, by a control unit, a drive level of a reset gate signal for resetting process of each of the horizontal CCD according to a gain setting value of an amplifier in an analog front end circuit configured as a signal processing circuit with respect to output from each of the horizontal CCD; and generating a reset gate signal corresponding to a drive level determined by the control unit, and outputting the generated reset gate signal to the horizontal CCDs. The level determining step includes: lowering the reset gate signal drive level when the amplifier gain setting value is relatively low, and raising the reset gate signal drive level when the amplifier gain setting value is relatively high.

It is noted that the computer program product according to the present invention includes those distributable to general-purpose computer systems adaptable to implement various program codes, for example, through storage mediums such as CDs, FDs and MOs provided in a computer-readable form or communications mediums such as networks. The program-adaptive processing is implemented on the computer systems by providing the types of program product in the computer-readable form.

The foregoing and other objects, features and advantages of the present invention will become apparent from a more detailed description based on the following embodiments of the present invention with reference to the accompanying drawings. It is noted that the system referred to in the present specification includes logical aggregates composed of more than one apparatus, wherein the apparatuses constituting each aggregate are not limited to those in the same casing.

These and other features and aspects of the invention are set forth in detail below with reference to the accompanying drawings in the following detailed description of the embodiments.

### BRIEF DESCRIPTION OF THE DRAWINGS

FIG. 1 is a block diagram showing a one-channel output-type CCD and the signal processing configuration.

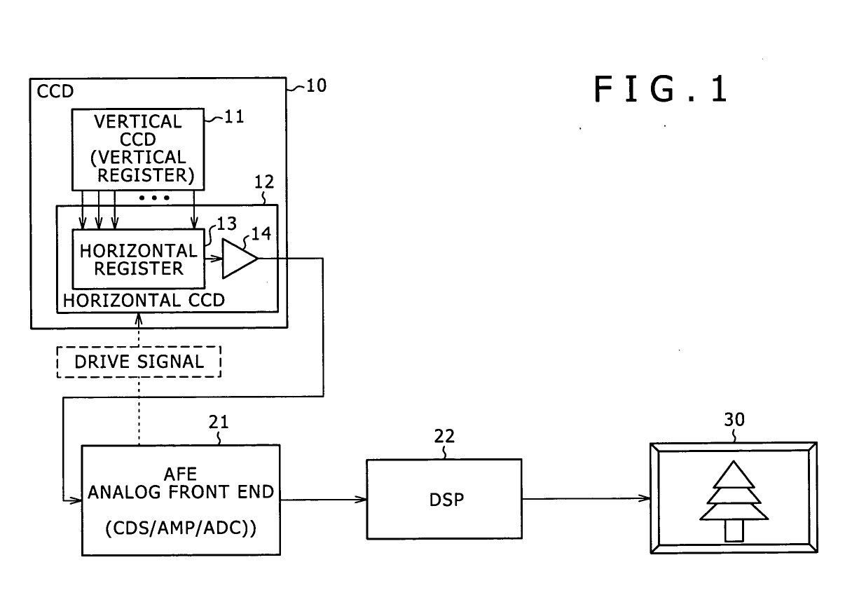

FIG. 2 is a block diagram showing a two-channel output-type CCD and the signal processing configuration.

FIG. 3 is a block diagram showing one configuration of an image capture apparatus, as well as of a signal processing apparatus, according to one embodiment of the present invention.

FIG. 4 illustrates a detailed configuration of a CCD.

FIG. 5 is a block diagram showing one configuration of an analog front end (AFE) of the image capture apparatus or the signal processing apparatus, together with a detailed configuration of a control unit, according to one embodiment of the present invention.

FIG. 6 is a graphic representation showing one example of setting of a reset gate signal drive level with respect to a gain setting value of an amplifier in the AFE.

FIG. 7 is a graphic representation showing another example of setting of the reset gate signal drive level with respect to the gain setting value of the amplifier in the AFE.

FIG. 8 illustrates one example of analyzing of a factor of occurrence of a level difference between left and right images with respect to a two-channel output CCD.

FIG. 9 illustrates different example of analyzing of the factor of occurrence of a level difference between left and right images with respect to the two-channel output CCD.

FIG. 10 illustrates further different example of analyzing of the factor of occurrence of a level difference between left and right images with respect to the two-channel output CCD.

FIG. 11 illustrates still further different example of analyzing of the factor of occurrence of a level difference between left and right images with respect to the two-channel output CCD.

FIG. 12 illustrates yet further different example of analyzing of the factor of occurrence of a level difference between left and right images with respect to the two-channel output CCD.

FIG. 13 illustrates yet further different example of analyzing of the factor of occurrence of a level difference between left and right images with respect to the two-channel output CCD.

FIGS. 14A and 14B are graphic representations showing a specific processing based on input of a reset gate (RG) signal into a horizontal CCD.

FIGS. 15A and 15B are state diagrams showing a specific processing based on input of the reset gate (RG) signal into the horizontal CCD.

FIGS. 16A and 16B are state diagrams showing a specific processing based on input of the RG signal into the horizontal CCD.

FIGS. 17A and 17B are graphic representations showing an example of resetting based on input of different RG signals.

FIGS. 18A and 18B are graphic representations showing a signal difference according to a difference between higher and lower RG signal drive levels with respect to the RG signals.

FIG. 19 is a flowchart for illustrating a sequence of RG signal setting according to an embodiment of the present invention.

### DETAILED DESCRIPTION OF EMBODIMENTS

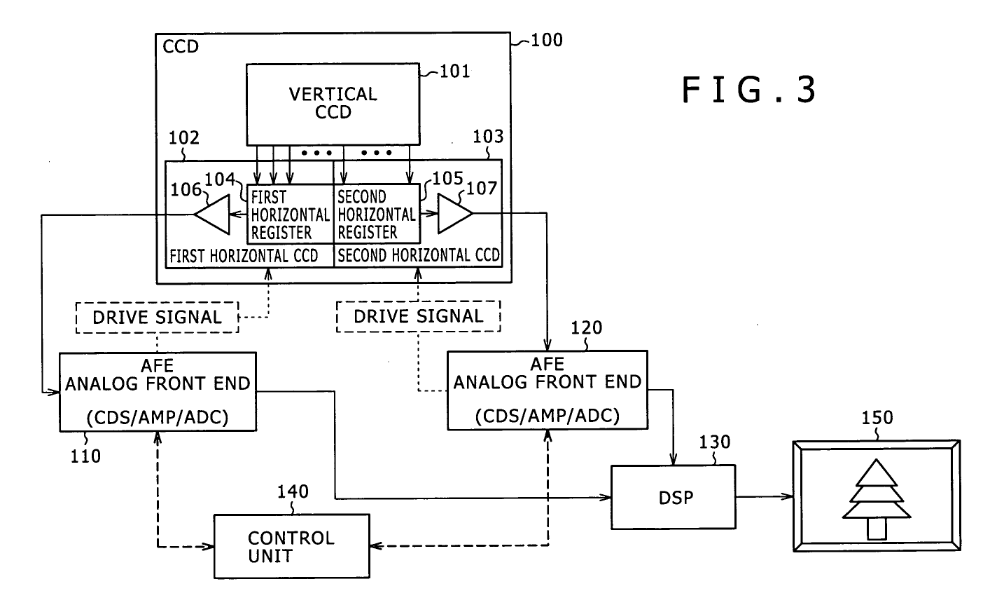

An image capture apparatus, a signal processing apparatus, a signal processing method and a computer program product are now described in detail with reference to accompanying drawings. To begin with, one configuration of the image capture apparatus, as well as of the signal processing apparatus, according to one embodiment of the present invention is described with reference to FIG. 3.

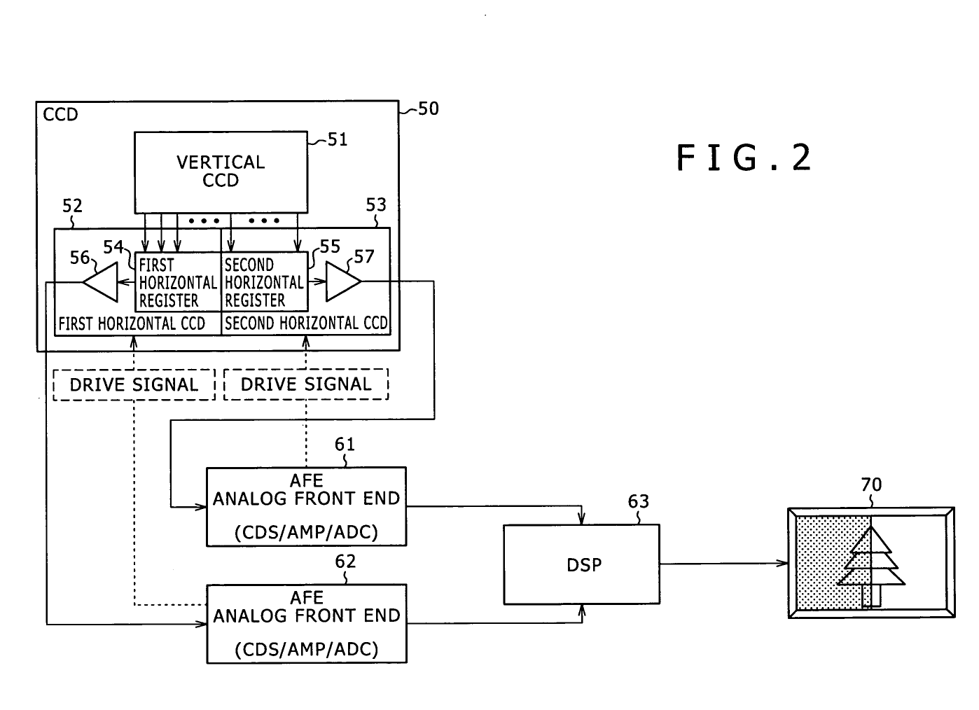

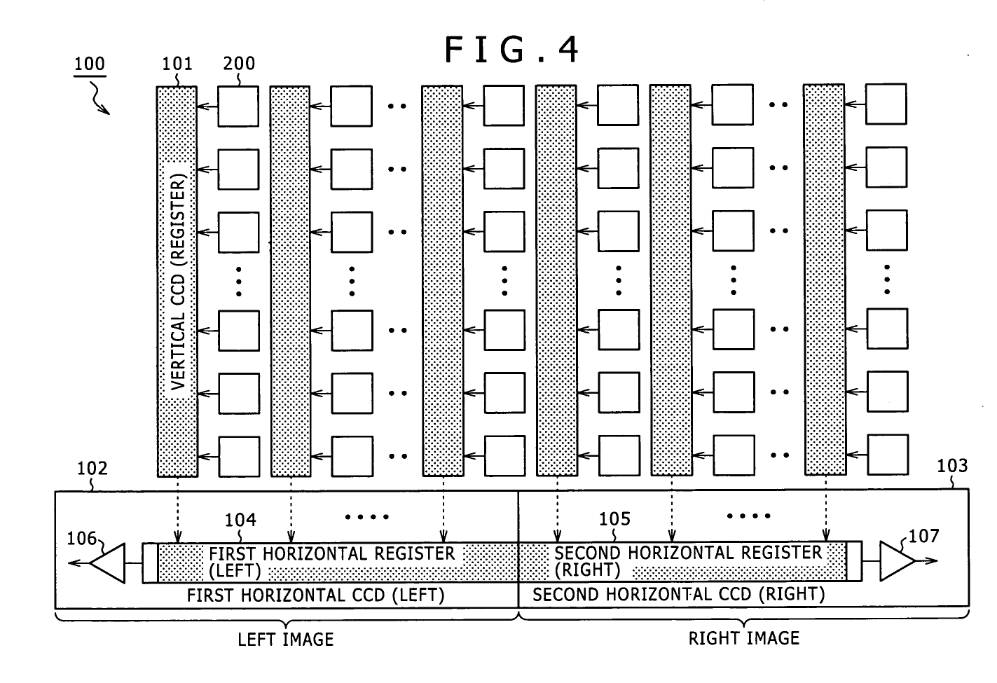

Like the CCD configuration previously described with reference to FIG. 2, a CCD 100 shown in FIG. 3 is divided into two or more areas to provide an output configuration on a divided area basis, or is in the form of a two-channel output CCD. A detailed configuration of the CCD 100 is described with reference to FIG. 4.

The CCD 100 has a large number of photo detectors (PDs) 200 as photoelectric converting elements, and outputs voltage signals based on accumulated charges in these photo detectors (PDs) 200. The CCD 100 outputs pixel information from different channels respectively in such a manner as to divide into two image capture areas for one frame in the center in a horizontal direction. The CCD 100 also has a vertical CCD (or vertical register) 101 and first and second horizontal CCDs 102 and 103 corresponding to one line. The vertical CCD 101 transfers the accumulated charges in the photo detectors (PDs) 200 on a line basis in a vertical direction.

The horizontal CCDs 102 and 103 accumulate the transferred charges for one line through the vertical CCD 101 in horizontal registers 104 and 105, and transfers the accumulated charges on a pixel basis into output amplifiers 106 and 107 to amplify charge information after being converted into voltage. The output amplifiers 106 and 107 are of floating diffusion amplifiers output, as voltage signals, charge information corresponding to the respective divided area images. The image information generated by the photo detectors (PDs) 200 of the CCD 100 in this manner is outputted from two output channels through the two output amplifiers 106 and 107.

Specifically, the first horizontal CCD 102 outputs, through the first output amplifier 106, a signal based on the charge information outputted from the photo detectors (PDs) 200 included in an area corresponding to a left image, while the second horizontal CCD 103 outputs, through the second output amplifier 107, a signal based on charge information outputted from the photo detectors (PDs) 200 included in an area corresponding to a right image.

Referring to FIG. 3 again, the processing with respect to output signals of the two output amplifiers 106 and 107 is described. Output of the first output amplifier 106 in the CCD 100, which is image signal information corresponding to the left image is inputted into an analog front end (AFE) 110. The analog front end (AFE) 110 is composed of circuits such as a CDS circuit for canceling a noise in input signals, an amplifier (AMP) for performing gain control and a digital converting unit (ADC) for performing A/D conversion. The circuits perform signal processing to generate, for example, a 12-bit digital signal (0 (min) to 4095 (max)) from an analog signal, and is outputted the generated signal to a digital signal processor (DSP) 130.

On the other hand, output of the second output amplifier 107 in the CCD 100, which is image signal information corresponding to the right image is inputted into an analog front end (AFE) 120. The analog front end (AFE) 120 is also composed of circuits such as a CDS circuit for performing canceling of noise in input signals, an amplifier (AMP) for performing gain control and a digital converting unit (ADC) for performing A/D conversion. Likewise, the circuits give effect to the signal processing, causing a 12-bit digital signal (0 (min) to 4095 (max)), for example, to be generated, and then outputs the generated signal to the digital signal processor (DSP) 130.

The digital signal processor (DSP) 130 generates one frame image through synthesizing and signal processing with respect to the digital signals from the two analog front ends (AFEs) 110 and 120 to provide an output image 150.

The image capture apparatus and the signal processing apparatus according to one embodiment of the present invention include a control unit 140 which outputs control signals to the two analog front ends (AFEs) 110 and 120. The control signals outputted from the control unit 140 to the two analog front ends (AFEs) 110 and 120 include the following two types of signals.
(1) Gain control signals: Settings of the gain control amplifiers (AMPs) in the analog front ends (AFEs) 110 and 120, and
(2) RG control signals: Drive level values (or drive power values) of reset gate (RG) signals in the control signals respectively inputted into the horizontal CCDs 102 and 103 through the analog front ends (AFEs) 110 and 120.

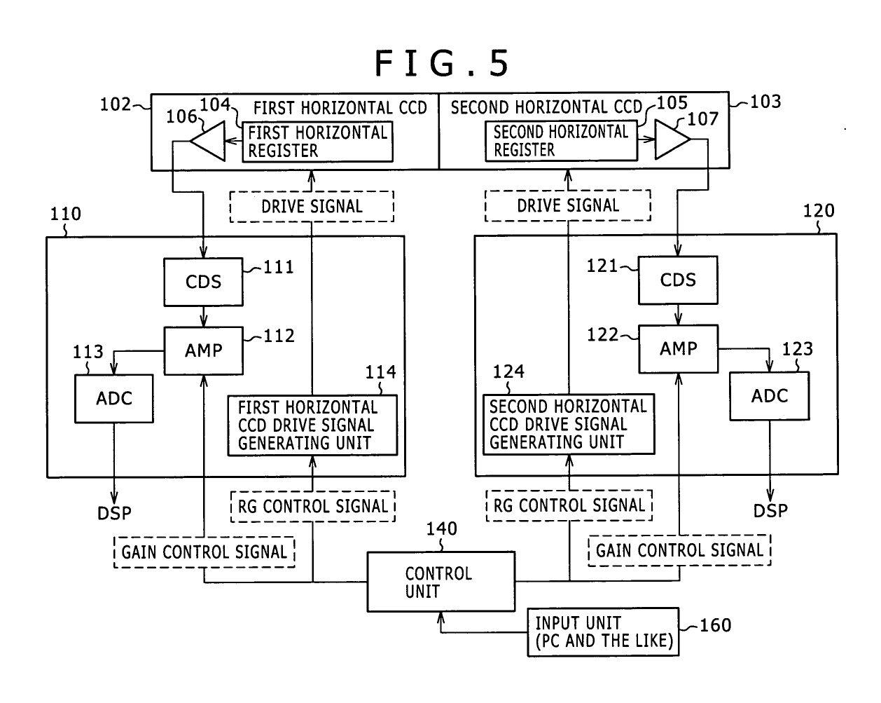

FIG. 5 is a view showing each configuration of the two analog front ends (AFEs) 110 and 120, together with the output signals of the control unit 140. The analog front end (AFE) 110 has a CDS 111 for cancelling noise in input signals, an amplifier (AMP) 112 for performing gain control and a digital converting unit (ADC) 113 for performing A/D conversion, wherein output of the output amplifier 106 based on the charge information in the first horizontal CCD 102 is inputted, causing the 12-bit digital signal (0 (min) to 4095 (max)), for example, to be generated from the analog signal, and then outputs the generated signal to the digital signal processor (DSP) 130.

The analog front end (AFE) 110 further has a first horizontal CCD drive signal generating unit 114. The first horizontal CCD drive signal generating unit 114 outputs, to the first horizontal CCD 102, signals such as a timing control signal for discharging etc. of the accumulated charges as a register value in the first horizontal CCD 102 and a reset signal. The first horizontal CCD 102 accumulates the charge information corresponding to the left half of one horizontal line in one frame image, line-by-line sequential basis, and needs to output the accumulated charge information in sequence through the output amplifier 106. For that reason, the first horizontal CCD drive signal generating unit 114 outputs the timing control signal and the reset gate (RG) signal as a horizontal CCD reset signal.

Likewise, the other right analog front end (AFE) 120 includes a CDS 121 for cancelling a noise in input signals, an amplifier (AMP) 122 for performing gain control and a digital converting unit (ADC) 123 for performing AD conversion. The output of the output amplifier 107 based on the charge information in the second horizontal CCD 103 is inputted into the right analog front end. Thus, for example, the 12-bit digital signal (0 (min) to 4095 (max) is generated from an analog signal, then the generated signal is outputted the generated signal to the digital signal processor (DSP) 130.

A second horizontal CCD drive signal generating unit 124 of the analog front end (AFE) 120 outputs, to the second horizontal CCD 103, signals such as a timing control signal for discharging etc. of the accumulated charges as a register value in the second horizontal CCD 103, and a reset signal. The second horizontal CCD 103 accumulates the charge information corresponding to the right half of one horizontal line in one frame image, line-by-line sequential basis, and needs to output the charge information in sequence through the output amplifier 107. For that reason, the second horizontal CCD drive signal generating unit 124 outputs the timing control signal and the reset gate signal as the horizontal CCD reset signal.

As previously described, the control unit 140 outputs, to the two analog front ends (AFEs) 110 and 120, each of the control signals, or:
(a) Gain control signals (gain setting values): Settings of the gain control amplifiers (AMPs) 112 and 122 of the analog front ends (AFEs) 110 and 120; and
(b) RG control signals (RG drive level setting values): Drive level (power) values of the reset gate (RG) signals included in the control signals respectively inputted into the horizontal CCDs 102 and 103 through the analog front ends (AFEs) 110 and 120.

The control unit 140 determines and outputs the RG drive level setting value based on each gain setting value of the amplifiers 112 and 113 of the analog front ends (AFEs) 110 and 120. Each gain setting value of the amplifiers (AMPs) 112 and 122 in the analog front ends (AFEs) 110 and 120 may be determined at will while making observation of an output image, for example. One configuration is included, for example, which is adaptable to set the gain value through an input unit 160 of the equipment such as PCs, in which case, gain controlling is performed so as to lower the gain when an output image is displayed bright, and raise the gain when the output image is displayed dark.

The control unit 140 determines the RG drive level setting value based on the gain setting value, and outputs the gain setting value and the RG drive level setting value respectively as the gain control signals and the RG control signals to the analog front ends (AFEs) 110 and 102. The analog front ends (AFEs) 110 and 120 respectively obtain the gain setting values of the amplifiers (AMPs) 112 and 122 in the analog front ends (AFEs) 110 and 120 based on the gain control signals inputted from the control unit 140, and further output, as drive signals, the level-established RG signals (or reset gate signals) based on the RG drive level setting values to the first horizontal CCD 102 and the second horizontal CCD 103 through the first horizontal CCD drive signal generating unit 114 and the second horizontal CCD drive signal generating unit 124 of the analog front ends (AFEs) 110 and 120.

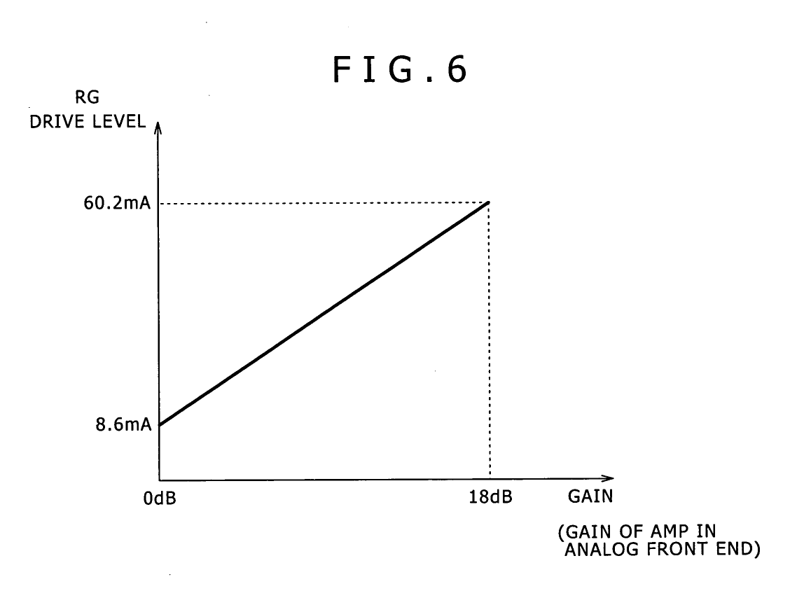

As previously described, the control unit 140 determines and outputs the RG drive level setting value based on the gain setting value. Determination of the RG drive level setting value is made based on a table or a computational expression held in the control unit 140. The control unit 140 determines the RG drive level setting value corresponding to the gain setting value based on a relation as shown in FIG. 6, for example.

Specifically, as shown in FIG. 6, when each gain setting value of the amplifiers (AMPs) 112 and 122 in the analog front ends (AFEs) 110 and 120 is low, the RG drive level is set at a relatively low value. Conversely, when each gain setting value of the amplifiers (AMPs) 112 and 122 in the analog front ends (AFEs) 110 and 120 is high, the RG drive level is set at a relatively high value. In one example shown in FIG. 6, an attempt to determine the RG drive level according to the amplifier (AMP) gain is made based on the setting condition under which the RG drive level is considered to be given in the range from 8.6 mA to 60.2 mA with respect to the amplifier (AMP) gain of 0 dB to 18 dB.

In this manner, the control unit 140 outputs, to the analog front ends (AFEs) 110 and 120, the control signals providing the relatively low-valued RG drive level when each gain setting value of the amplifiers (AMPs) 112 and 122 in the analog front ends (AFEs) 110 and 120 is low, or the control signals providing the relatively high-valued RG drive level when each gain setting value of the amplifiers (AMPs) 112 and 122 in the analog front ends (AFES) 110 and 120 is high.

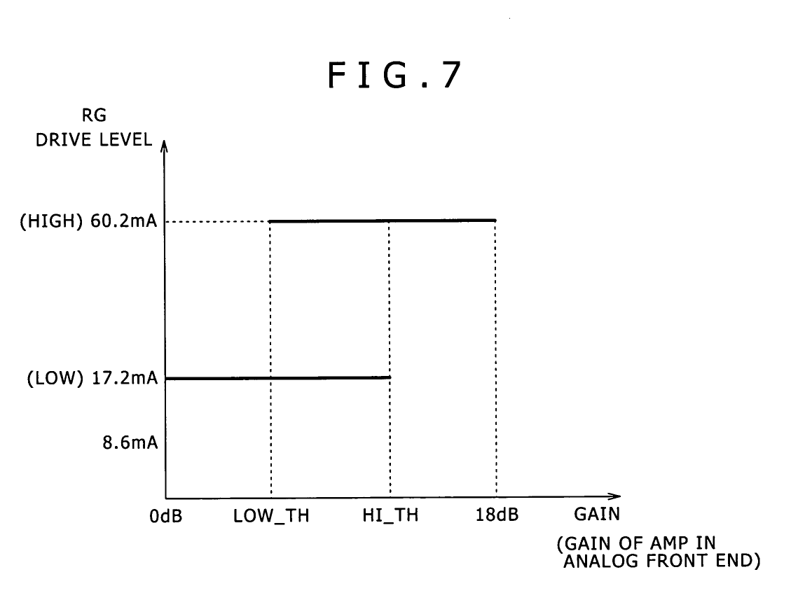

It is noted that while there is shown, in FIG. 6, one example of setting of the RG drive level at different values according to each individual value of the gain setting values, it is also allowable to take one configuration which sets the RG drive level in multiple stages. For example, as shown in FIG. 7, assuming that there is an application of one configuration which sets the RG drive level in two stages (HIGH and LOW), it is also allowable to change the RG drive level in stages according to a threshold value as follows:
(a) The RG drive level is set at HIGH, when the gain setting value is not less than an upper threshold value (HI_TH),
(b) The RG drive level is set at LOW, when the gain setting value is not more than a lower threshold value (LOW_TH), and
(c) The present setting is maintained intact in other cases.

As previously described, one embodiment of the present invention is configured to control with the RG drive level changed according to each gain setting value of the amplifiers (AMPs) 112 and 122 in the analog front ends (AFEs) 110 and 120. A control configuration of which eliminates a difference between left and right levels of the output image, making it possible to obtain a high quality image which appears with no conspicuous boundary. Specifically, the control unit 140 shown in FIGS. 3 and 5 determines the RG drive level according to the gain setting value with reference to each gain setting value of the amplifiers (AMPs) 112 and 122 in the analog front ends (AFEs) 110 and 120. For example, the control unit 140 controls to lower the reset gate signal drive level when the amplifier gain setting value is lower than a predetermined lower threshold value, and to raise the reset gate signal drive level when the amplifier gain setting value is higher than a predetermined upper threshold value. Alternatively, the control unit 140 determines the reset gate signal drive level according to the amplifier gain setting value by referring to the table listing a correspondence between each gain setting value of the amplifiers in the analog front ends (AFE) and the setting of the reset gate signal drive level.

It is noted that in the configuration shown in FIG. 5, the control unit 140 outputs setting information on the reset gate signal drive level to the horizontal CCD drive signal generating units 114 and 124 in the analog front ends (AFEs) 110 and 120. The horizontal CCD drive signal generating units 114 and 124 control the drive level of the reset gate signal based on the setting information inputted from the control unit 140 to perform an output process of the RG signals to the horizontal CCDs.

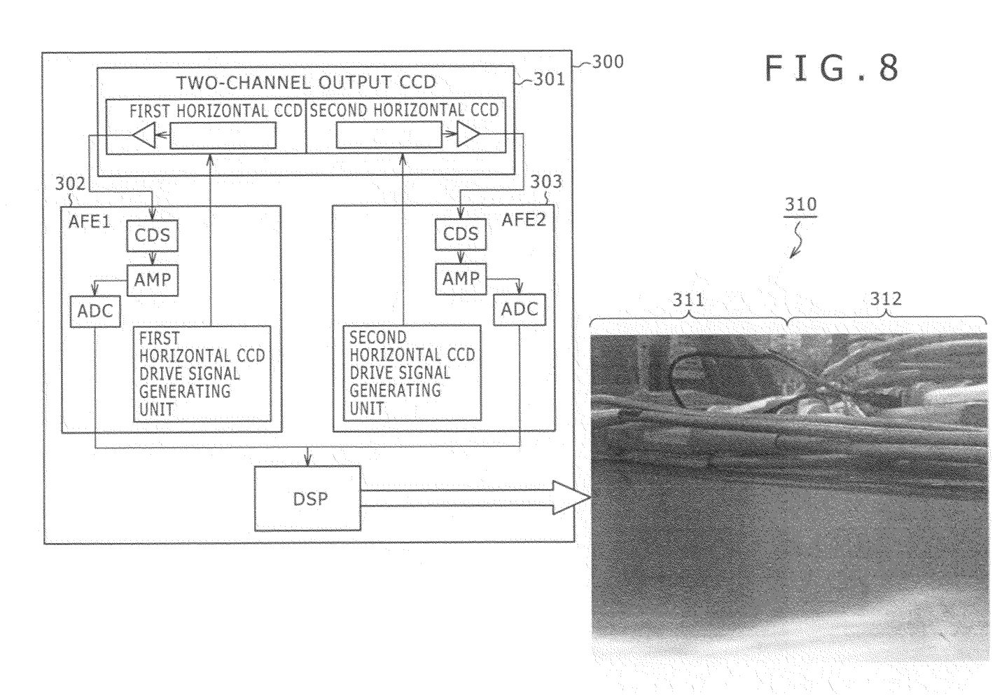

The reasons why the controlling like the above makes it possible to eliminate the difference between the left and the right levels are now described. To begin with, analyzing of the factors of appearance of a boundary between the areas with respect to an image from each output channel in the case of the two-channel output CCD is described with reference to FIGS. 8 to 13.

The analyzing was conducted using an image capture apparatus 300 shown in FIG. 8. The image capture apparatus used is of a type having a two-channel output CCD 301 like that previously described with reference to FIG. 3. Output of the left and the right horizontal CCDs is inputted respectively into individual analog front ends (AFEs) 302 and 303 through the output amplifiers, and further into the DSP as digital data, causing an output image 310 from the DSP to be obtained. The analog front ends (AFES) 302 and 303 are ICs having the same specifications. Each IC has, in addition to a CDS, an AMP and an ADC which are to perform input signal processing, a CCD drive signal generating unit configured as a horizontal CCD drive signal generator. It is noted that there is, practically, an emitter circuit on the post-stage of CCD output, causing signals with impedance reduced to be inputted into the analog front ends (AFEs) 302 and 303.

The output image 310 obtained without any special processing makes a difference in luminance level between a left area image 311 and a right area image 312, resulting in an image whose boundary between the left and the right area images is recognizable, as shown in FIG. 8. Specifically, a left image display appears darker, while a right image display appears brighter, with the resultant boundary between the left and the right image capture areas. Each gain setting value of the amplifiers (AMPs) in the analog front ends (AFEs) 302 and 302 is held at 27 dB.

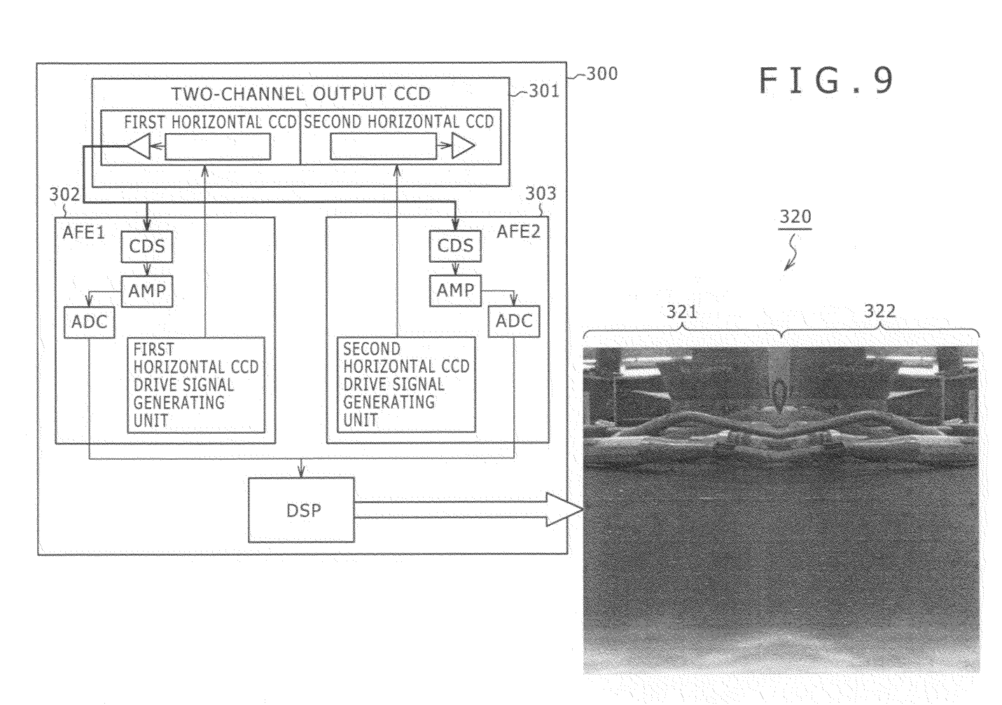

FIG. 9 shows one example of analyzing made with a configuration which allows common CCD output to be inputted into the analog front ends (AFEs) 302 and 303. As shown in FIG. 9, an output image 320 is obtained by processing in such a manner as to supply, to both the analog front ends (AFEs) 302 and 303, output of the first horizontal CCD configured to output an image signal corresponding to the left area image. The output image 320 obtained appears as a bisymmetrical image, and there is no difference in luminance level between a left area image 321 and a right area image 322.

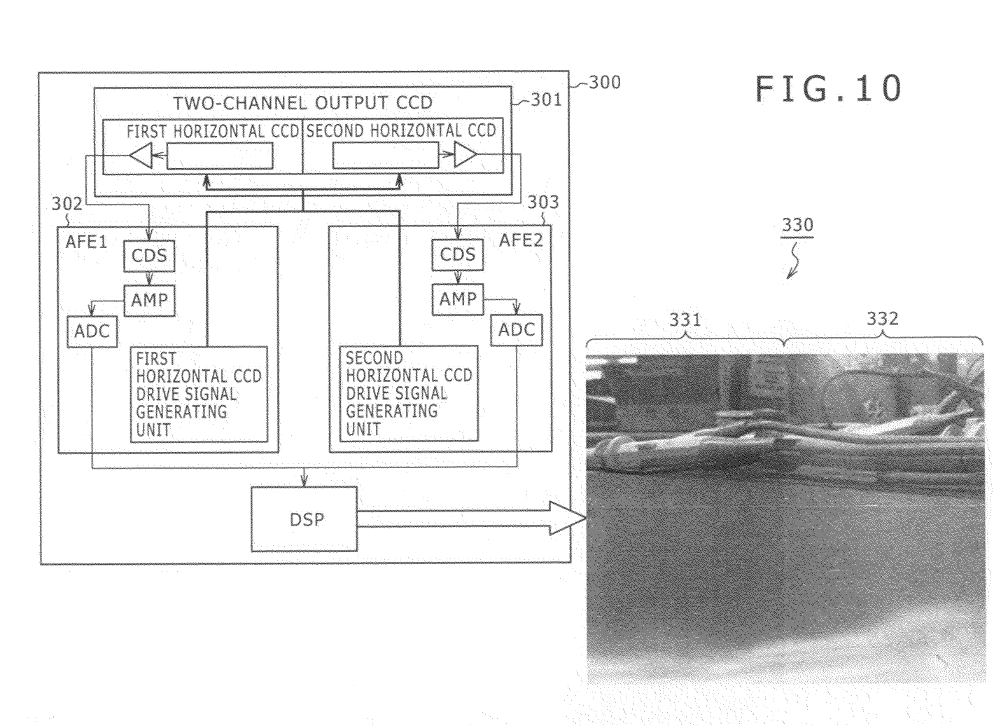

FIG. 10 shows one example of analyzing made with a configuration which makes equal the drive signals to be inputted into the left and the right horizontal CCDs. As shown in FIG. 10, an output image 330 obtained makes a difference in luminance level between a left area image 331 and a right area image 332, resulting in an image whose boundary between the left and the right area images is recognizable. Specifically, a left image display appears darker, while a right image display appears brighter, with the resultant boundary between the left and the right image capture areas.

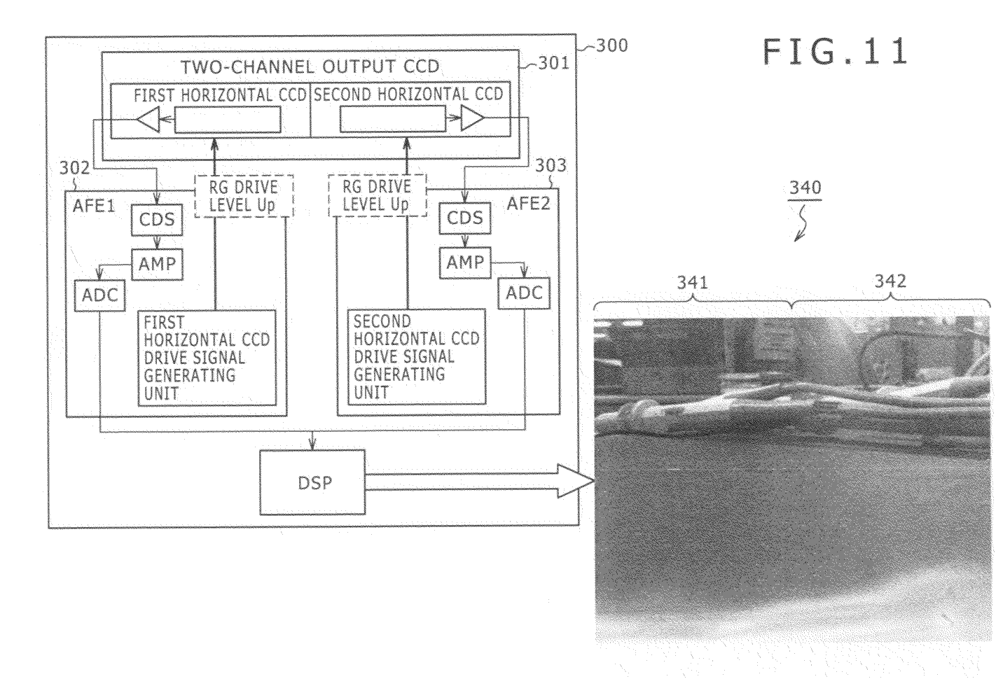

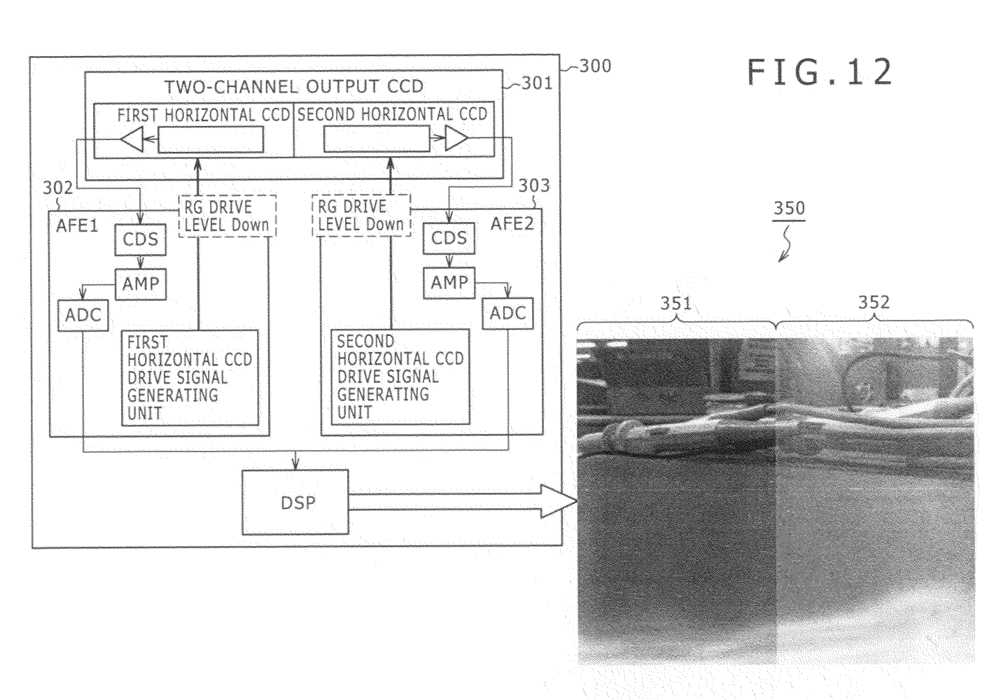

FIGS. 11 and 12 show examples of analyzing made with a configuration which changes the drive power of the RG (the reset gate signal) to be inputted into each horizontal CCD. FIG. 11 shows a case where the drive power of the RG to be inputted into each horizontal CCD is increased, and FIG. 2 shows a case where the drive power of the RG to be inputted into each horizontal CCD is decreased. When the increased (leveled-up) RG drive power as shown in FIG. 11 is provided, an output image 340 has no great difference in luminance level between a left area image 341 and a right area image 342. On the other hand, when the decreased (leveled-down) RG drive power as shown in FIG. 12 is provided, an output image 350 has a difference in luminance level between a left area image 351 and a right area image 352, resulting in an image whose boundary is recognizable.

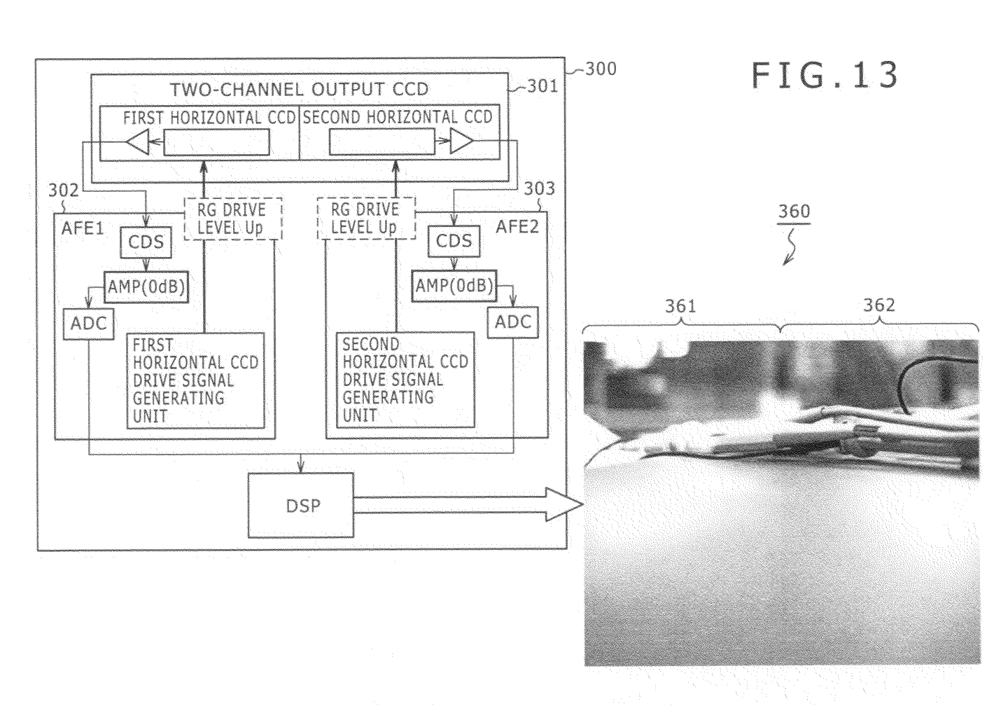

FIG. 13 shows one example of analyzing made with a configuration having the RG drive power increased like the configuration shown in FIG. 11, and resetting of the amplifiers (AMPs) in the analog front ends (AFES) 302 and 303 to a lower value (0 dB) by opening lens of the image capture apparatus. In this case, an output image 360 is obtained, with a left area image 361 slightly higher in luminance level (or brighter) than a right area image 362, on the contrary to the other level differences.

The results of analyzing respectively shown in FIGS. 8 to 13 are now considered.

In the output image 310 obtained in a normal state without any special processing as shown in FIG. 8, it is seen that the boundary at the center is clearly recognized

In the output image 320 resulting from entering the common signal into the two AFES shown in FIG. 9, there is almost no recognition of the difference between the left and the right area images. The reason why the output image 320 shown in FIG. 9 appears as the bisymmetrical image is that after the right-hand input signals are once stored in the memory on a line basis, the DSP makes feed of signals so as to allow the latest signal to precede the others (LIFO). The signals inputted into the two AFEs are common, so that it reveals that the variations in the AFEs are rarely attributable to the difference between the left and the right area images.

It is considered that the difference is occurred at the point of time of signal output of CCDout1/CCDout2 specified as the output from the left and the right horizontal CCDs, since the difference between the left and the right area images is observed in the output image 330 resulting from entering the equal drive signals into the left and the right horizontal CCDs shown in FIG. 10.

From the results shown in FIGS. 8 to 10, it is considered that the most major factor of occurrence of the difference between the left and the right area images lies in a difference in characteristics between the left and the right horizontal CCDs. The factor in determining the horizontal CCD characteristics is supposed to be roughly classified into the following two categories:
Factor A: There is a difference in transfer characteristics between the left and the right horizontal CCDs, and
Factor B: There is a difference in characteristics between the left and the right output amplifiers (or floating diffusion amplifiers) at the final stage of the horizontal CCDs.

As shown in FIG. 10, judging from the fact that there is also the level difference in the output image 330 resulting from entering the equal horizontal drive signals into the left and the right horizontal CCDs, it is hard to consider that the level difference is caused by the difference in transfer characteristics between the left and the right horizontal CCDs as stated in the factor A. Thus, as shown in FIGS. 11 and 12, an attempt to change the RG (reset gate) drive signals was made.

FIG. 11 shows the case where the RG drive power is increased, in which case, the output image 340 makes no great difference in luminance level between the left area image 341 and the right area image 342. On the other hand, when the RG drive power is decreased as shown in FIG. 12, the output image 350 makes the difference in luminance level between the left area image 351 and the right area image 352, resulting in the appearance of a more conspicuous boundary on the contrary with the above. FIG. 13 shows the case where the RG drive power is set to a high level as that of FIG. 11, and the gain is reset to 0 dB when a subject is bright. When the subject is dark as shown in FIG. 12, the left image display appears darker than the right image display. On the other hand, when the subject is bright as shown in FIG. 13, the left image display conversely becomes somewhat brighter.

As the drive signals with respect to the horizontal CCDs, various signals (H1/H2/HL/RG) are inputted from the horizontal CCD drive signal generating units for each time to control charge outputting and resetting etc. In this case, an attempt to adjust phases of rise and drop pulses of these signals H1/H2/HL/RG in units of 260 psec was made, but the result was that the boundary between the areas is further highlighted or longitudinal stripe noise is produced, so that an image quality could be hardly improved upon.

In the foregoing, judging from the results in FIGS. 11, 12 and 13, it is presumed that the CCD output level is greatly affected by the variations in characteristics of the output amplifiers (or the floating diffusion amplifiers) in the left and the right horizontal CCDs, resulting in the appearance of the boundary between the left and the right image capture areas. It is also considered that as a solution of the above, means of correcting the difference in characteristics between the left and the right amplifiers by increasing the RG drive power when the subject is dark and has a small amount of transfer charges, or conversely, decreasing the RG drive power of RG when the subject is dark and has a large amount of transfer charges permits the boundary to be made inconspicuous.

Specifically, as shown in FIGS. 11 and 12, when the subject is brighter and has smaller amount of transfer charges, as compared with the case in FIG. 13, the processing of increasing the RG drive power is judged to be effective in eliminating the difference between the left and the right levels, as shown in FIG. 11. As shown in FIG. 13, when the subject is bright and has a large amount of transfer charge, there occurs a phenomenon that a balance between the left and the right area images goes into reverse. That is, the left image display becomes somewhat brighter in contrast with a balance between the left and the right area images shown in FIG. 12 when the subject relatively is dark, so that the processing of decreasing the RG drive power is judged to be effective in eliminating the difference between the left and the right levels.

When the subject is dark and has a small amount of transfer charges, the analog front end (AFE) amplifier (AMP) gain is set at a relatively high value. On the other hand, when the subject is bright and has a large amount of transfer charges, the analog front end (AFE) amplifier (AMP) gain is set at a relatively low value.

The processing according to on embodiment of the present invention changes the RG drive power according to the amplifier (AMP) gain setting value. Specifically, as previously described with reference to FIGS. 6 and 7, the RG drive power is increased when the subject is dark and has a high gain of the amplifier (AMP), while the RG drive power is decreased when the subject is bright and has a low gain of the amplifier (AMP). By this construction, the difference between the left and the right levels with respect to the output image is eliminated.

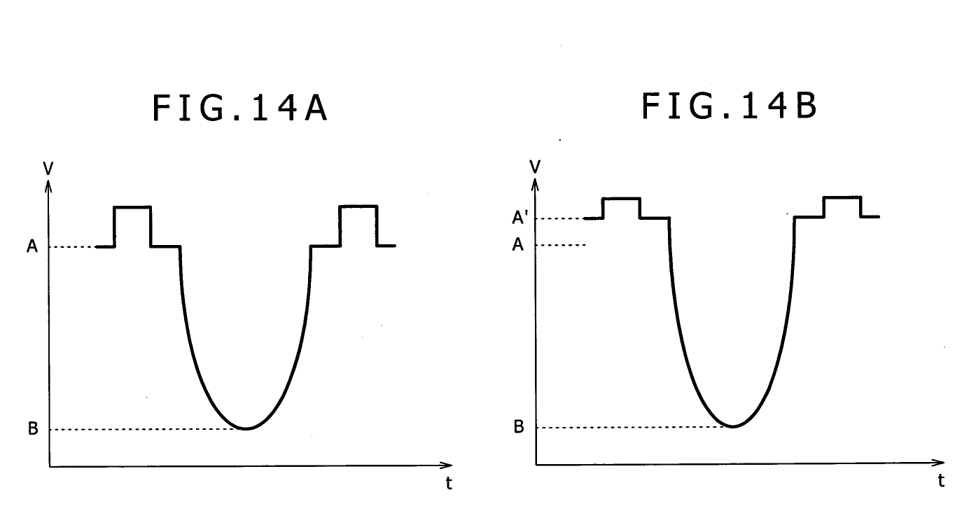

The processing based on input of the reset gate (RG) signal into the horizontal CCD is now specifically described with reference to FIGS. 14 to 18. FIG. 14 shows a temporal transition of the output signal level of the horizontal CCD, where a horizontal axis indicates a time (t), and a vertical axis indicates a potential (V) as of the amount of accumulated charges in the horizontal CCD. Output of the signals causes a drop in potential from a reference potential A of the horizontal CCD shown in FIG. 14A to a potential B. The amount [A-B] of transfer charges at this time is outputted as a pixel signal.

The reset gate (RG) signal outputted from the horizontal CCD drive signal generating unit of each analog front end (AFE) is inputted into the horizontal CCD, as a signal for performing restoration of the potential from the potential B, which is of the dropped potential resulting from output of the pixel signal, to the reference potential A. However, even after the reset gate (RG) signal is inputted, the residual charges occur depending on the characteristics of a floating capacity of the output amplifier unit in the horizontal CCD, causing an increase of the reference potential by a portion corresponding to the residual charges in the floating capacity of the output amplifier unit. As a result, a change of the reference potential to A′ occurs as shown in FIG. 14B. At this time, the output level results in [A′-B], where A′-B>A-B holds true, causing the phenomenon that the output level rises.

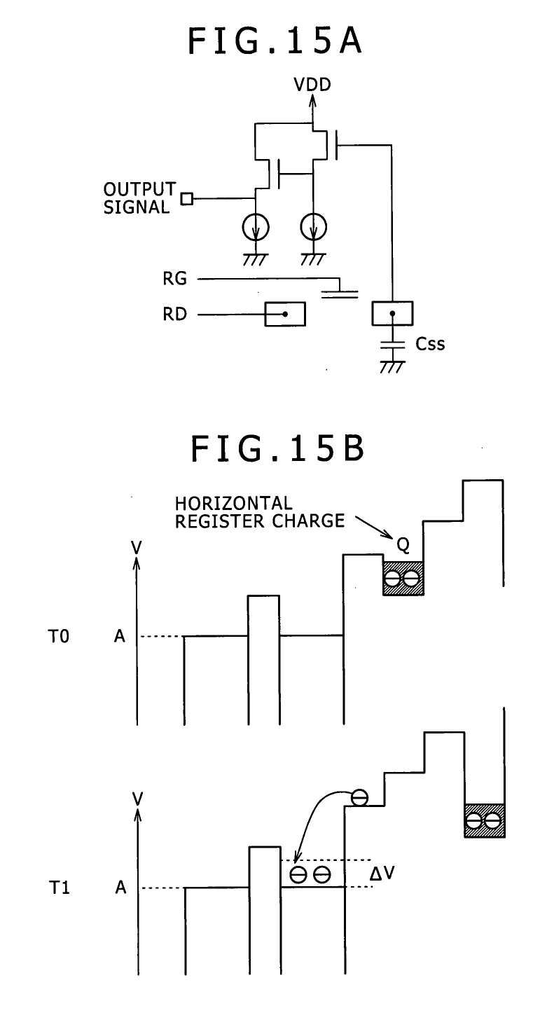

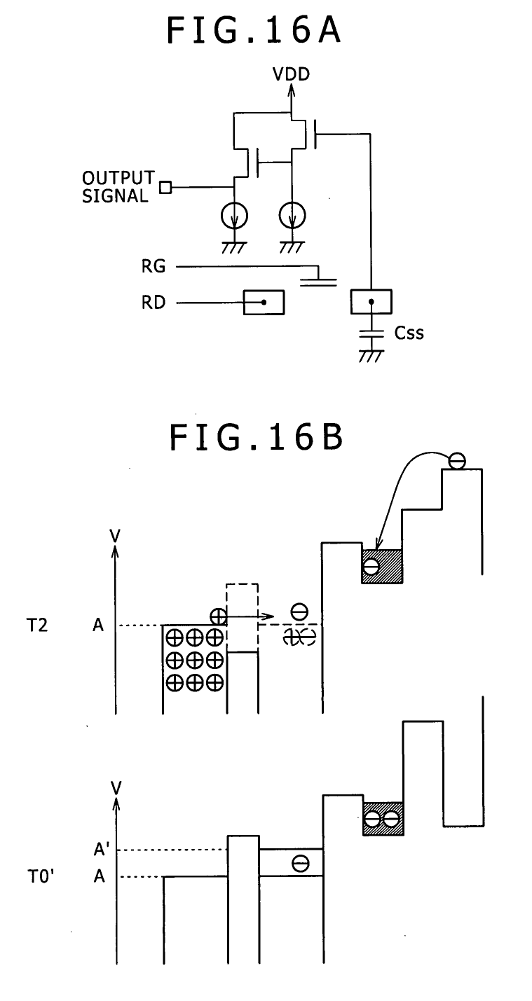

Resetting and charging/discharging based on the RG signal with respect to the horizontal CCD are described with reference to FIGS. 15 and 16. FIG. 15A shows a mechanism of the horizontal CCD, as well as of the output amplifier unit. The charges accumulated in the horizontal CCD are supposed to be accumulated in a floating capacity Css shown in FIG. 15A, causing the voltage corresponding to the accumulated charges in the floating capacity Css as the output signal of the output amplifier. RG indicates the reset gate signal, and RD indicates a reset gate potential. Each of state diagrams at T0, T1, T2 and T0′ in FIGS. 15 and 16 shows the state transition of the output amplifier in the horizontal CCD before and after the reset gate signal is inputted. The state at each time is now described.

### [Time T0]

The state at time T0 shows a state immediately after resetting with the RG is made. The horizontal register (or the register in the horizontal CCD) in a previous stage of the output amplifier unit has subsequent signal charges Q. At this time, the floating capacity Css of the output amplifier unit shows the same potential as the reset gate potential RD.

### [Time T1]

The state at time T1 shows a state in which the signal charges Q are flowing into the floating capacity Css of the output amplifier unit. As a result of the flowing of the charges described above, the potential rises by |ΔV|=|Q/Css| corresponding to the charges Q, where ΔV is outputted as the output signal by the amplifying circuit.

### [Time T2 Shown in FIG. 16]

The state at time T2 shown in FIG. 16 shows a state at a starting time of RG resetting.

When an RG terminal is turned on, charges (+) are injected from a power RD terminal, the Css potential is neutralized up to the reference potential A. Thus, the reset gate (RG) signal is utilized as the signal for performing restoration of the Css potential to the reference potential through neutralizing of the residual charges in the floating capacity of the floating diffusion amplifier unit.

However, in this case, a completion of resetting before achievement of satisfactory neutralizing of the Css potential by injection of the charges (+) from the power RD terminal brings about a state at time T0′ shown in FIG. 16, that is, the reference potential results in A′>A. Thus, the reference potential is supposed to be set at a higher value.

A potential A′ in the state at time T0′ is equivalent to the reference potential A′ shown in FIG. 14B as previously described.

The two-channel output CCD employs the two, or the left and the right output amplifiers as previously described with reference to FIG. 3, wherein it is difficult to completely match the charging/discharging characteristics of the output amplifier floating capacity Css. For that reason, when there is the difference in floating diffusion amplifier characteristics between the output amplifier units in the horizontal CCDs even in the case where imaging with the same subject illuminance in the left and the right image capture areas results in matching of the charges in the left and the right image capture areas, the residual charges occur in only one of the output amplifiers according to the RG pulse rise time, causing the difference between the reference potentials before and after resetting, leading to contributions toward subsequent output signal differences.

Particularly, when the subject illuminance is low and with smaller difference between CCD output potentials, the amplifier gain of each analog front end (AFE) is set largely. Thus, the influence of the slightly residual charges is amplified to give a larger difference, and as a result, easily appears as the level difference in the output image. Thus, when raising (or leveling up) the amplifier gain of each analog front end (AFE) (normally, when the subject illuminance is low), it is possible to reduce the difference between the left and the right levels by making the reference potentials of the left and the right output amplifiers equal to the RD potential as much as possible in such a manner as to forcibly discharge away the residual charges by leveling up the reset gate (RG) pulse drive power.

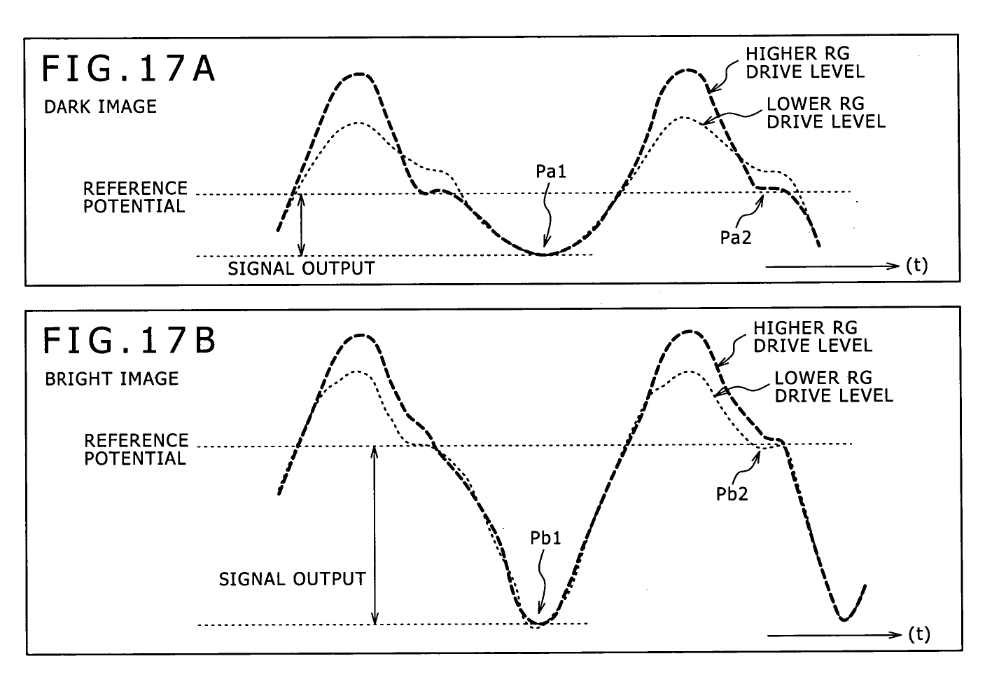

On the other hand, when the subject is bright and has a large amount of charges accumulated as the floating capacity, it becomes necessary to take a long period from the time when the RG pulse is turned on to the time when resetting to the reference potential is attained through neutralizing with the RD potential. Accordingly, the drive power of the RG pulse set to relatively lower level as compared with that for the dark subject makes it possible to reduce the time taken to attain to the reference potential. This phenomenon is shown in FIG. 17.

FIG. 17 shows waveforms of output from the output amplifier through the horizontal CCD. The output waveforms in FIG. 17A are those for a dark image, while the output waveforms in FIG. 17B are those for a bright image. FIGS. 17A and 17B show the transitions of output waveform of the output amplifiers when the reset signal (RG) signal drive level is set at a higher and at a lower, respectively.

With respect to the dark image shown in FIG. 17A, the setting of the reset gate (RG) signal drive level at the higher value is shorter in a period from a point of time (pa2) at which resetting to the reference potential is attained in response to the reset gate signal from a point of time (pa1) at which signal output is completed. On the other hand, with respect to the bright image shown in FIG. 17B, the setting of the reset gate (RG) signal drive level at the lower value is shorter in a period from a point of time (pb2) at which resetting to the reference potential is attained in response to the reset gate signal from a point of time (pb1) at which signal output is completed.

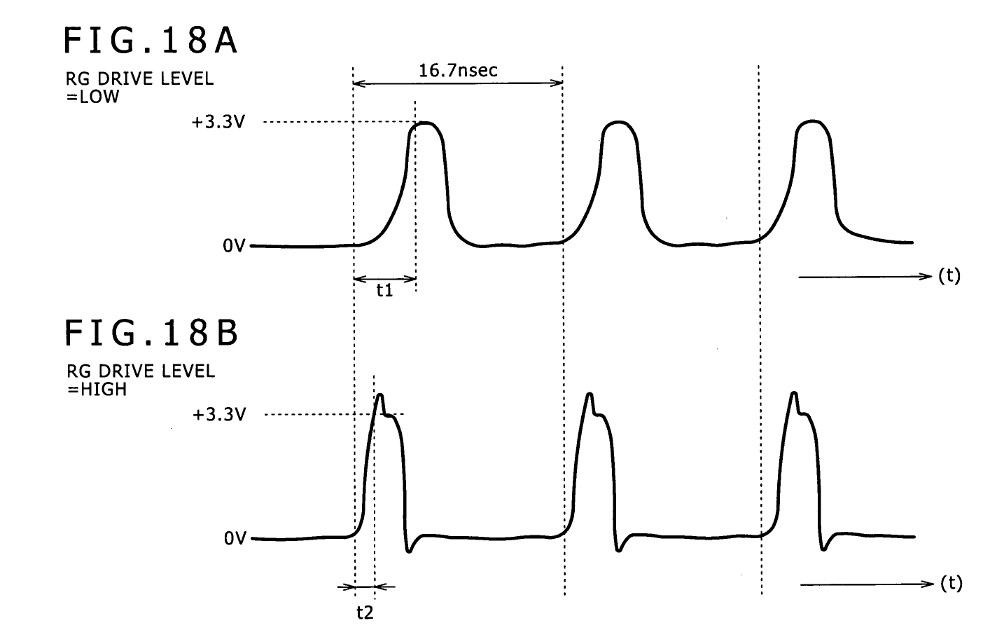

FIG. 18 shows a difference of signals depending on the difference between the higher and the lower reset gate (RG) signal drive levels of the RG signals. When the reset gate signal drive level is set at the higher value, the resetting to the predetermined potential is attained in a shorter period of time, but the occurrence of overshoot is involved. Specifically, the injection of the charges up to the restoration to the reference potential is made at higher speed, but the overshoot is supposed to occur. On the other hand, when the reset gate (RG) signal drive level is set at the lower value, the resetting to the predetermined potential is attained in a relatively longer period of time, that is, the injection of the charges up to the restoration to the reference potential is made at lower speed, but the overshoot hardly occurs. There is a difference in time t1>t2 as shown in FIG. 18.

In the configuration shown in FIG. 5, the control unit 140 controls to determine the reset gate signal drive level according to each gain setting value of the amplifiers 112 and 122 in the analog front ends 110 and 120, and output the reset gate signal having an output pulse shape corresponding to the determined drive level.

With respect to the dark image shown in FIG. 17A, the setting of the reset gate (RG) signal drive level at the higher value is shorter in the period from the point of time (pa2) at which the resetting to the reference potential is attained in response to the reset gate signal from the point of time (pa1) at which the signal output is completed, even if the overshoot is taken into considerations. On the other hand, with respect to the bright image shown in FIG. 17(B), the setting of the reset gate (RG) signal drive level at the lower value into execution of the processing as that configured to cause no overshoot is shorter in the period from the point of time (pb2) at which the resetting to the reference potential is attained in response to the reset gate signal from the point of time (pb1) at which the signal output is completed.

As described above, one embodiment of the present invention realizes the configuration which outputs the high quality image appearing with no conspicuous boundary by providing well-balanced left and right images in such a manner as to change the reset gate (RG) signal drive level according to the amplifier gain setting value in each analog front end. Specifically, as previously described with reference to FIGS. 6 and 7, the difference between the left and the right levels is eliminated by the following processing:

leveling up the RG drive power when the subject is dark and has higher amplifier (AMP) gain, and

leveling down the RG drive power when the subject is bright and has lower amplifier (AMP) gain is configured to eliminate.

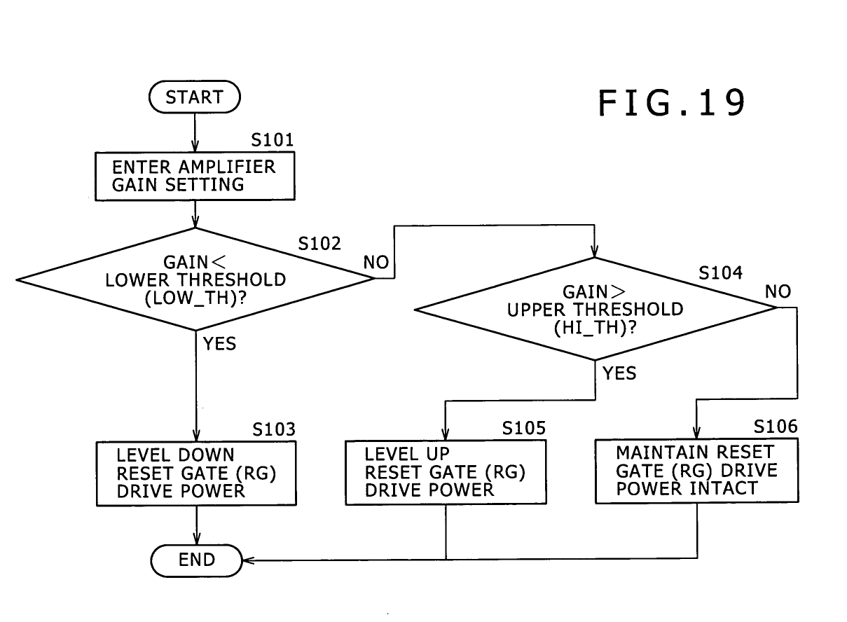

A reset gate (RG) signal control sequence to be processed in -the image capture apparatus or the signal processing apparatus according to an embodiment of the present invention is now described with reference to a flowchart in FIG. 19. The processing shown in FIG. 19 includes a processing sequence to be executed by the control unit 140 in the apparatus shown in FIG. 3. In addition, the sequence in the processing flow shown is to perform a switch control of reset gate (RG) signal in two stages, HIGH and LOW, as previously described with reference to FIG. 7.

First of all, in Step S101, an amplifier gain setting value is inputted. The gain setting value inputted is of gain setting values of the amplifiers (AMPs) in the analog front ends (AFEs), or values inputted while making observation of the output image, for example.

For the dark image, the higher gain setting value is set, while for the bright image, the lower gain setting value is set.

In Step S102, the gain setting value [GAIN] set is compared with a predetermined lower threshold value [LOW_TH] of the gain, followed by making judgment whether or not GAIN<LOW_TH holds true. When the result of judgment in the Step S102 is that GAIN<LOW_TH holds true, the processing goes to Step S103, then the processing of lowering the reset gate (RG) drive level (power) is performed.

When the judgment in the Step S102 is that GAIN<LOW_TH does not hold true, the processing goes to Step S104, where the determined gain setting value [GAIN] is compared with a predetermined upper threshold value [HI_TH] of the gain, followed by making judgment whether or not GAIN>HI_TH holds true. When the result of judgment in the Step S104 is that GAIN>HI_TH holds true, the processing goes to Step S105, then the processing of raising the reset gate (RG) drive level (power) is performed.

Further, when the result of judgment in the Step S104 is that GAIN>HI_TH does not hold true, the processing is advanced to Step S106, then the processing of maintaining the reset gate (RG) drive level (power) intact is performed.

Continuation of the series of processing during the output of the image is adaptable to hold down the lower-valued reset gate (RG) drive level (power) for the bright image (for the smaller amplifier gain of the AFE), while providing the higher-valued reset gate (RG) drive level (power) for the dark image (or for the larger amplifier gain of the AFE). As a result, discharging of the output amplifier in each horizontal CCD is smoothly carried out, causing the difference between the left and the right images to be suppressed, resulting in the realization of the output of the high quality image with no conspicuous boundary.

Although the present invention has been described in detail with reference to specific embodiments, it will be obvious to those skilled in the art that various modifications and/or variations of the embodiments may be made without departing from the spirit and scope of the present invention. In other words, it is to be understood that the disclosure of the present invention has been made in the form of embodiments, and the present invention shall be thus interpreted as illustrative and not in a limiting sense. Therefore, the scope of the present invention is to be determined in consideration of the appended claims.

The series of processing previously described in the present specification may be implemented with hardware or software or in a combination of the hardware with the software. In implementing the processing with the software, it is possible to run a program product containing the processing sequence through installation into a memory in a dedicated hardware-integrated computer or alternatively, through installation into a general-purpose computer adaptable to perform various processing.

The computer program product may be preliminarily recorded in recording mediums such as hard disks and ROMs (Read Only Memories). Alternatively, it is also possible to store (record) the computer program product temporarily or permanently in removal recording mediums such as flexible discs, CD-ROMs (Compact Disc Read Only Memories), MOs (Magneto Optical) discs, DVDs (Digital Versatile Discs), magnetic discs and semiconductor memories. The types of removable recording mediums may be provided in the form of so-called package software, for example.

It is noted that the computer program product is not limited to those installed from the types of removable recording mediums into the computers, and it is also allowable to transfer the program product from download sites to the computers by radio or by cable over a network including LANs (Local Area Networks) and the Internet, in which case, the computers receive the program product transferred in this manner for installation into their integrated recording mediums such as the hard disks.

It is noted that various processing in the present specification is not limited to those implemented in time sequence according to the descriptive procedure, and it is also allowable to perform the various processing concurrently or individually at need or depending on the processing power of an apparatus configured to implement the processing. In addition, the system referred to in the present specification includes logical aggregates composed of more than one apparatus, wherein the apparatuses constituting each aggregate are not limited to those in the same casing.

According to the exemplified embodiments of the present invention, the configuration is provided, which outputs individually image signals corresponding to each divided area of the image capture area, performs signal processing and synthesizing with respect to the output signals to provide output image, wherein a drive level of a reset gate signal for reset process of horizontal CCD adapted to generate the CCD output signal is changed according to a gain setting value of amplifier in the analog front end circuit adapted to perform the CCD output signal processing. Specifically, the reset gate signal drive level is lowered when the amplifier gain setting value is relatively low, and the reset gate signal drive level is raised when the amplifier gain setting value is relatively high. By this configuration, the level difference in the output image corresponding to each divided area of the image capture area is eliminated, so that a high quality image with inconspicuous boundary is obtained.

The present application claims benefit of priority of Japanese Patent Application No. 2006-282234 filed in the Japanese Patent Office on Oct. 17, 2006, the entire content of which being incorporated herein by reference.

What is claimed is:

1. An image capture apparatus comprising:
a charge coupled device (CCD) for individually outputting an image capture signal corresponding to each divided area of an image capture area through a horizontal CCD;
an analog front end circuit, configured as a signal processing circuit with respect to output from the horizontal CCD, including an amplifier and a digital converting unit for converting into digital data; and
a control unit for controlling a drive level of a reset gate signal for resetting process of the horizontal CCD,
wherein the control unit controls the drive level of the reset gate signal according to a gain setting value of the amplifier to lower the drive level of the reset gate signal when the gain setting value of the amplifier is relatively low, and to raise the drive level of the reset gate signal when the gain setting value of the amplifier is relatively high.

2. The image capture apparatus according to claim 1, wherein the control unit controls the drive level of the reset gate signal to lower the drive level of the reset gate signal when the gain setting value of the amplifier is lower than a predetermined lower threshold value, and to raise the drive level of the reset gate signal when the gain setting value of the amplifier is higher than a predetermined upper threshold value.

3. The image capture apparatus according to claim 1, wherein the control unit determines the drive level of the reset gate signal according to the gain setting value of the amplifier by referring to a table listing a correspondence between the gain setting value of the amplifier and a setting value of the drive level of the reset gate signal.

4. The image capture apparatus according to claim 1, wherein:
the analog front end circuit includes a horizontal CCD drive signal generating unit configured as an output unit of the reset gate signal,
the control unit outputs setting information on the drive level of the reset gate signal to the horizontal CCD drive signal generating unit, and
the horizontal CCD drive signal generating unit controls the drive signal of the reset gate signal based on the setting information inputted from the control unit, thereby performing outputting process with respect to the horizontal CCD.

5. The image capture apparatus according to claim 1, wherein:
the reset gate signal is a signal for performing restoration of a potential of the horizontal CCD to a reference potential through neutralizing of residual charges in a floating capacity of a floating diffusion amplifying unit constituting the horizontal CCD, and
the control unit determines the drive level of the reset gate signal according to the gain setting value of the amplifier in the analog front end circuit and causes an output of a reset gate signal having an output pulse shape corresponding to the determined drive level.

6. A signal processing apparatus for controlling a signal outputted from a charge coupled device (CCD) which individually outputs image capture signals corresponding to each of divided areas of an image capture area through different horizontal CCDs, the signal processing apparatus comprising:
a control unit for determining a drive level of a reset gate signal for performing restoration of each horizontal CCD according to a gain setting value of an amplifier in an analog front end circuit configured as a signal processing circuit with respect to output from each of the horizontal CCDs, and
a drive signal generating unit for generating a reset gate signal corresponding to the drive level determined by the control unit, and outputting the generated reset gate signal to each of the horizontal CCDs,
wherein the control unit controls the drive level of the reset gate signal to lower the drive level of the reset gate signal when the amplifier gain setting value is relatively low, and to raise the drive level of the reset gate signal when the amplifier gain setting value is relatively high.

7. The signal processing apparatus according claim 6, wherein the control unit controls the drive level of the reset gate signal to lower the drive level of the reset gate signal when the gain setting value of the amplifier is lower than a predetermined lower threshold value, and to raise the drive level of the reset gate signal when the gain setting value of the amplifier is higher than a predetermined upper threshold value.

8. The signal processing apparatus according claim 6, wherein the control unit controls the drive level of the reset gate signal to determine the drive level of the reset gate signal according to the gain setting value of the amplifier by referring to a table listing a correspondence between the gain setting value of the amplifier and a drive level setting value of the reset gate signal.

9. The signal processing apparatus according to claim 6, wherein:
the reset gate signal is a signal for performing restoration of a potential of the horizontal CCD to a reference potential through neutralizing of residual charges in a floating capacity of a floating diffusion amplifier unit in each of the horizontal CCDs, and
the control unit controls the reset gate signal to determine the drive level of the reset gate signal according to the gain setting value of the amplifier included in the analog front end circuit, and to output the reset gate signal having an output pulse shape corresponding to the determined drive level.

10. A signal processing method for controlling a signal outputted from a charge coupled device (CCD) which individually outputs image capture signals corresponding to each of divided areas of an image capture area through different horizontal CCDs, the signal processing method comprising the steps of:
determining, by a control unit, a drive level of a reset gate signal for reset process of each of the horizontal CCDs according to a gain setting value of an amplifier included in an analog front end circuit configured as a signal processing circuit with respect to output from each of the horizontal CCD; and
generating a reset gate signal corresponding to a drive level determined by the control unit, and outputting the generated reset gate signal to the horizontal CCDs,
wherein the determining step includes:
lowering the drive level of the reset gate signal when the gain setting value of the amplifier is relatively low, and
raising the drive level of the reset gate signal when the gain setting value of the amplifier is relatively high.

11. A computer program product for implementing a signal processing to a signal processing apparatus which controls a signal outputted from a charge coupled device (CCD), the CCD individually outputting image capture signals corresponding to each of divided areas of an image capture area through different horizontal CCDs, the computer program product including instructions executed by the signal processing apparatus to cause the signal processing apparatus to perform a method comprising the steps of:
determining, by a control unit, a drive level of a reset gate signal for reset process of each of the horizontal CCDs according to a gain setting value of an amplifier in an analog front end circuit configured as a signal processing circuit with respect to output from each of the horizontal CCD; and
generating a reset gate signal corresponding to a drive level determined by the control unit, and outputting the generated reset gate signal to the horizontal CCDs,
wherein the determining step includes:
lowering the drive level of the reset gate signal when the gain setting value of the amplifier is relatively low, and
raising the drive level of the reset gate signal when the gain setting value of the amplifier is relatively high.
